(19) United States
(12) Patent Application Publication
(10) Pub. No.: US 2024/0419655 A1
(43) Pub. Date: Dec. 19, 2024

(54) AGGREGATION AND RECONCILIATION OF DATA EVENTS TO BE STORED ON CLOUD DATABASE

(71) Applicant: Blackthorn IP, LLC, Lehi, UT (US)

(72) Inventors: Ryan Taylor, Lehi, UT (US); Russell E. Fowles, Lehi, UT (US); Rob Mayfield, Lehi, UT (US)

(73) Assignee: Blackthorn IP, LLC, Lehi, UT (US)

(21) Appl. No.: 18/745,856

(22) Filed: Jun. 17, 2024

Related U.S. Application Data
(60) Provisional application No. 63/508,483, filed on Jun. 15, 2023.

(51) Int. Cl. G06F 16/23

(52) U.S. Cl. CPC G06F 16/2365; G06F 16/2379

(57) ABSTRACT

Data ingestion and reconciliation across multiple computing devices. A method includes receiving a candidate event to be stored on a cloud database, wherein the candidate event is provided by a remote data source, and wherein the remote data source generated the candidate event during an offline period when communication between the cloud database and the remote data source was unavailable. The method includes reconciling the candidate event against the cloud database by determining whether a conflicting event was stored on the cloud database during the offline period. The method includes, in response to determining there is no conflicting event stored on the cloud database during the offline period, committing the candidate event to the cloud database.

### CROSS-REFERENCE TO RELATED APPLICATIONS

This application claims the benefit under 35 U.S.C. § 119 (e) of U.S. Provisional Patent Application No. 63/508,483 filed Jun. 15, 2023, entitled “DATA AGGREGATION AND DATABASE SCHEMAS FOR TIME-DEPENDENT DATA MANAGEMENT,” which is incorporated herein by reference in its entirety, including but not limited to those portions that specifically appear hereinafter, the incorporation by reference being made with the following exception: In the event that any portion of the above-referenced application is inconsistent with this application, this application supersedes said above-referenced application.

### TECHNICAL FIELD

The disclosure relates to systems and methods for data ingestion and storage and particularly relates to ingesting data across a plurality of independent sources and partitioning and querying the ingested data.

### BACKGROUND

Project management is a multifaceted discipline that involves coordinating a wide array of activities to ensure the successful completion of a project. Construction project management can be particularly difficult when attempting to track and organize the schedule, timeline, location, and availability of diverse types of equipment and personnel. Construction projects typically involve numerous stakeholders, including contractors, subcontractors, suppliers, regulatory bodies, and so forth, all of whom should by synchronized to meet project deadlines. Delays or miscommunications among these parties may lead to significant project overruns in budget or timeframe.

In an effort to streamline the project management process, some project managers attempt to utilize traditional scheduling software to track the schedule and whereabouts of different equipment and personnel. However, traditional scheduling software fails to organize, track, and reconcile data that is retrieved from disparate data sources. Data reconciliation is an important process in numerous industries, and particularly in the project management industry. In practice, data reconciliation can be challenging due to the vast amount of data and the complexity of data sources. This is particularly true when data is ingested asynchronously, and when some data events are ingested at a later time due to a remote computing device losing communication with a central server.

In view of the foregoing, described herein are systems, methods, and devices for data aggregation, normalization, and reconciliation. The systems, methods, and devices described herein may particularly be utilized to reconcile the truth of multiple conflicting data events.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. It will be appreciated by those of ordinary skill in the art that the various drawings are for illustrative purposes only. The nature of the disclosure, as well as other embodiments in accordance with this disclosure, may be more clearly understood by reference to the following detailed description, to the appended claims, and to the several drawings.

FIG. 1 is a schematic diagram of a system for data aggregation that can be implemented for increasing efficiency of computing systems for ingesting, storing, and analyzing data;

FIGS. 2A and 2B are schematic diagrams of an organization schema for data management and permissioned access to database entries.

FIG. 3 is a schematic block diagram illustrating components of a resource management platform;

FIG. 4 is a schematic diagram of a system for data communication between a resource management server and internal and external data sources;

FIG. 5 is a schematic diagram of a system for performing electronic data security measures on data received from an external data source;

FIG. 6 is a schematic diagram of a system for data storage and analysis on a cloud-based storage system with fault-tolerant servers;

FIG. 7 is a schematic diagram of a system and process flow for aggregating data from a plurality of disparate sources and then assigning the aggregated data to different project buckets on a database having granular user-based permissions;

FIG. 8 is a schematic diagram of a system and process flow for assigning unique data permissions to users associated with a database;

FIG. 9 is a schematic diagram of a system for managing and assessing data stored in internal and external calendars to assign users based on time-dependent data metrics;

FIG. 10 is a schematic diagram of an example data scheme for linking or matching data within a database;

FIGS. 11A and 11B are schematic diagrams of a system and process flow for ingesting and reconciling data that is generated by a remote data source when the remote data source could not communicate with a resource management server;

FIG. 12 is a schematic flow chart diagram of a method for data ingestion and reconciliation across multiple computing devices; and

FIG. 13 illustrates a block diagram of an example computing device in accordance with the teachings and principles of the disclosure.

### DETAILED DESCRIPTION

Disclosed herein are systems, methods, and devices for data ingestion and data reconciliation. The systems, methods, and devices described herein are utilized to ensure the truth of data events stored on a cloud-based database. In some cases, the cloud-based database stores information generated by numerous different computing devices, and in some cases, a data event is generated by a computing device when the computing device is “offline” and does not have real-time communication access to the cloud-based database. The systems, methods, and devices described herein are utilized to determine whether the data event represents the most recent and valid truth, and whether the data event should be committed to the cloud-based database.

Further described herein are systems, methods, and devices for database management and data analysis. Specifically disclosed herein are database systems for storing, querying, and analyzing independent datasets directed to different topics and assigned to different entities. Further disclosed herein are data ingestion processes for receiving and retrieving data from a plurality of independent sources and then partitioning that data across a database system.

In one example implementation, the systems, methods, and devices described herein form a resource management platform for construction project management. The resource management platform described herein manages the tasks and task units that must be performed to complete a project. The resource management platform additionally manages the personnel, equipment, vehicles, tools, rental agreements, labor budgets, equipment budgets, contracts, and tasks associated with the project. The resource management platform leverages machine learning algorithms and neural networks to perform real-time analysis of images, videos, documents, and other files to verify the authenticity of user inputs. The database schema described herein enables the resource management platform to provide real-time data analysis on interrelated but disparate datapoints received from different data sources, including datapoints pertaining to workers, equipment, rental agreements, tools, supplies, budgets, and so forth.

Numerous industries struggle with efficient data collection and organization. For example, the construct and project management industries are often required to manage copious quantities of equipment, supplies, and personnel. It can be challenging to track labor, equipment, and supplies in real-time while also tracking the completion of certain tasks. This same struggle applies to any industry that manages numerous disparate types of data that might be retrieved and updated from various sources.

Additionally, data aggregation generally presents numerous challenges, and these challenges are aggravated when data is retrieved from disparate sources that implement different protocols and conventions for classifying information. Even when data is gathered and summarized, further analysis is usually required before the aggregated data can be shared with, or communicated to, different audiences, or used as the basis for decision-making. Data aggregation includes collecting data, checking the data, verifying the data, transferring the data, and compiling the data, assessing quality of the data, packaging the data, disseminating the data, and reporting the data, and using the data for action. Each of these steps presents unique technical challenges when the data is retrieved from disparate sources that implement different conventions and protocols for classifying and organizing information.

Considering the foregoing, disclosed herein are systems, methods, and devices for resolving the technical challenges presented when aggregating data retrieved from one or more communication channels. The systems, methods, and devices described herein include means for securely and efficiently ingesting files and datapoints from a plurality of diverse sources, and then analyzing those files and datapoints to identify common classifications for the information described therein. The systems, methods, and devices described herein are implemented for classifying information, translating data describing the information, and then matching the data to “data buckets” that are associated with certain projects.

Before the structure, systems, and methods are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

The computer readable storage medium described herein can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the disclosure.

Aspects of the disclosure are described herein with reference to flowchart illustrations and/or block diagrams of methods, apparatuses (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

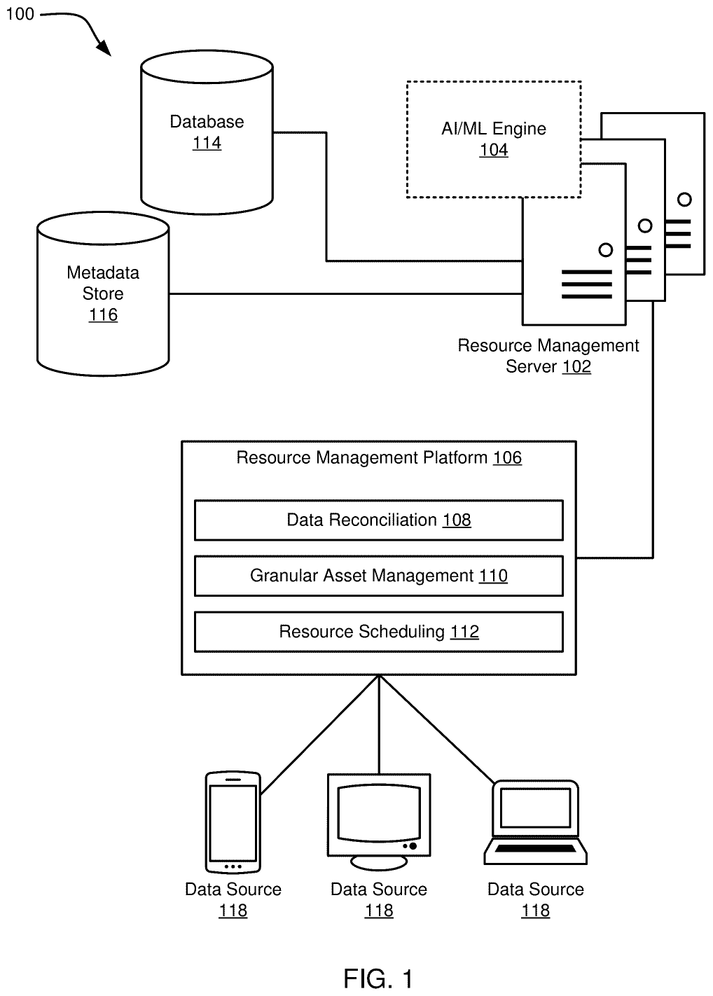

Referring now to the figures, FIG. 1 is a schematic diagram of a system 100 for data aggregation and reconciliation that can be implemented for increasing the efficiency of computing systems for ingesting, storing, and analyzing data. The system 100 includes a resource management server 102 that may include or utilize an artificial intelligence and/or machine learning (AI/ML) engine 104. The resource management server 102 processes operations for a resource management platform 106 that is made accessible to users by way of applications running on data sources 118. The resource management platform 106 includes numerous modules, and may at least include modules for data reconciliation 108, granular asset management 110, and resource scheduling 112. The system 100 includes a database 114 for storing ingested and partitioned data, training datasets, structured data, unstructured data, and so forth.

The resource management platform 106 is made accessible to a user by way of the data sources 118. The resource management server 102 renders a graphical user interface (GUI) for the resource management platform 106. The user utilizes the GUI of the resource management platform 106 to create an account, provide project data, provide asset and personnel data, provide project updates, communicate with other accounts, and so forth. The GUI of the resource management platform 106 is accessible by way of an application, web browser, or other interface.

The database 114 is a repository of information, datasets, images, structured data, unstructured data, and training datasets for the AI/ML engine 104. The resource management server 102 may access the database 114 by way of an Application Program Interface (API) over the network connection. The API allows the resource management server 102 to receive automatic updates from the database 114 as needed. In an embodiment, the database 114 is integrated on the resource management server 102 and is not independent of the storage and processing resources dedicated to the resource management server 102.

Data stored in the remote or cloud storage, such as the database 114, may include data, including images and related data, from many different entities, customers, locations, or the like. The stored data may be accessible to a classification system that includes a classification model, neural network, or other machine learning algorithm.

Each independent database instance within the database 114 is partitioned into a plurality of tables. In an example implementation, the resource management platform 106 is used for managing various construction projects implemented by different clients. Each client account may have separate tables for each construction projected that is being planned or executed by that client. The different client accounts are assigned independent database instances, so there is no threat of crosstalk or sharing of project information between different client accounts. One construction project may include a plurality of jobs, and each of the plurality of jobs may include a plurality of tasks that must be completed. In various implementations, the database 114 may include separate tables for each project, each job, and/or each task. The database 114 may include separate tables for storing a listing of employees or contractors, a listing of tasks to be executed, a listing of tools, a listing of equipment, a listing of construction schedules, a listing of work history data, and so forth.

The database 114 may include a plurality of database instances, wherein each database instance may be assigned to a different client account. In an implementation, the resource management platform 106 is implemented for ingesting, translating, and aggregating data for aggregated data packages, and in this case, the database 114 may include an independent database instance for each entity using the resource management platform 106. In an alternative embodiment, the data for each entity is stored in the same physical memory location, and permissions for reading or writing the data is controlled by way of permissions managed by the resource management platform 106.

The database 114 includes and/or communicates with a metadata store 116 and a bucket 202. In various implementations, the metadata store 116 and the bucket 202 may be considered a component of the database 114, and in other implementations, they may be separate database structures that operate independently of the database 114. The metadata store 116 includes a listing of where information is stored on the database 114. The metadata store 116 may specifically include tables storing metadata about non-structured files stored in the bucket 202, and the metadata store 116 may additionally include an indication of where those non-structured files can be located within the bucket 202. The bucket stores non-structured files such as videos, images, documents, PDFs, and other files.

The metadata store 116 comprises a table for media. The media table includes metadata information about all media stored in the bucket 202. The metadata information includes, for example, geographical coordinate information, name, purpose, classification (e.g., what the media is depicting or why the media was captured), and timestamp. The media table further includes an indication of where the media can be retrieved from the bucket 202. The media table on the metadata store 116 points to where the media itself is stored on the bucket 202 and further points to a table that describes the media. The table describing the media may include, for example, an independent table on the database 114 describing what is depicted in the media. For example, if the media includes an image of a grouping of tools, then the metadata store 116 may point to a table on the database 114 that identifies all tools that should be included within that specific grouping of tools depicted in the image. The media table on the metadata store 116 is a polymorphic many-to-many table. The media itself (stored on the bucket 202) may be applied to any other model or table.

The database 114 may be structured as a relational database. In a relational database, files and data are stored with predefined relationships to one another. The files and data are organized as a set of tables with columns and rows, and tables are used to hold information about the objects to be represented in the database 114.

The database 114 may be structured as a directed graph file system (which may be referred to as a semantic file system). The directed graph file system structures data according to semantics and intent, rather than location. The directed graph file system allows data to be addressed by content (associative access).

The data sources 118 may include, for example, mobile phones, laptops, personal computers, servers, server groups, tablets, image sensors, cameras, scanners, desktop computers, set-top boxes, gaming consoles, smart televisions, smart watches, fitness bands, optical head-mounted displays, virtual reality headsets, smart glasses, HDMI or other electronic display dongles, personal digital assistants, and/or another computing device comprising a processor (e.g., a central processing unit (CPU)), a processor core, image sensors, cameras, a field programmable gate array (FPGA), or other programmable logic, an application specific integrated circuit (ASIC), a controller, a microcontroller, and/or another semiconductor integrated circuit device, a volatile memory, and/or a non-volatile storage medium. The data sources 118 may comprise processing resources for executing instructions stored in non-transitory computer readable storage media. These instructions may be incorporated in an application stored locally to the data source 118, an application accessible on a web browser, and so forth. The application enables a user to access the user interface for the resource management platform 106 to check submissions, upload files, verify whether files are accurately uploaded, receive feedback from the AI/ML engine 104, and so forth.

In an embodiment, a user accesses an account associated with the resource management platform 106 by way of the data source 118. The user may be assigned a security role and location access to as many, or few, entities as is required by the user's position. Security roles restrict what information and/or functionality the user can access. The resource management platform 106 may be accessible on a mobile phone application. The mobile phone application uses the camera and networking capabilities of the mobile phone to capture images and upload those images to the resource management server 102 and AI/ML engine 104 for analysis.

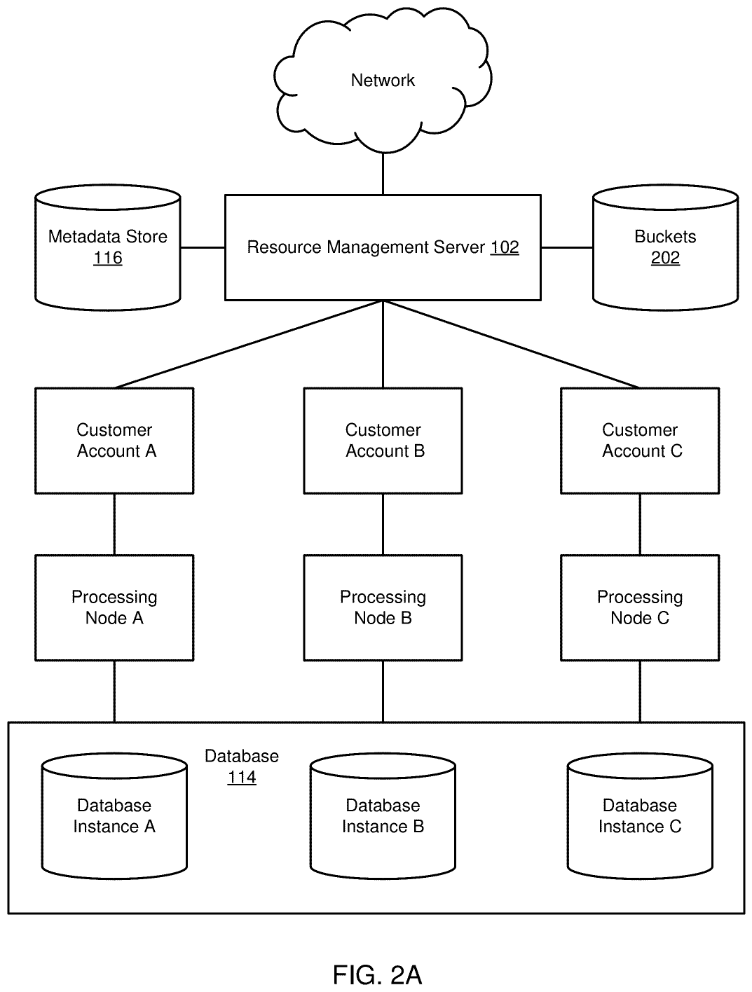

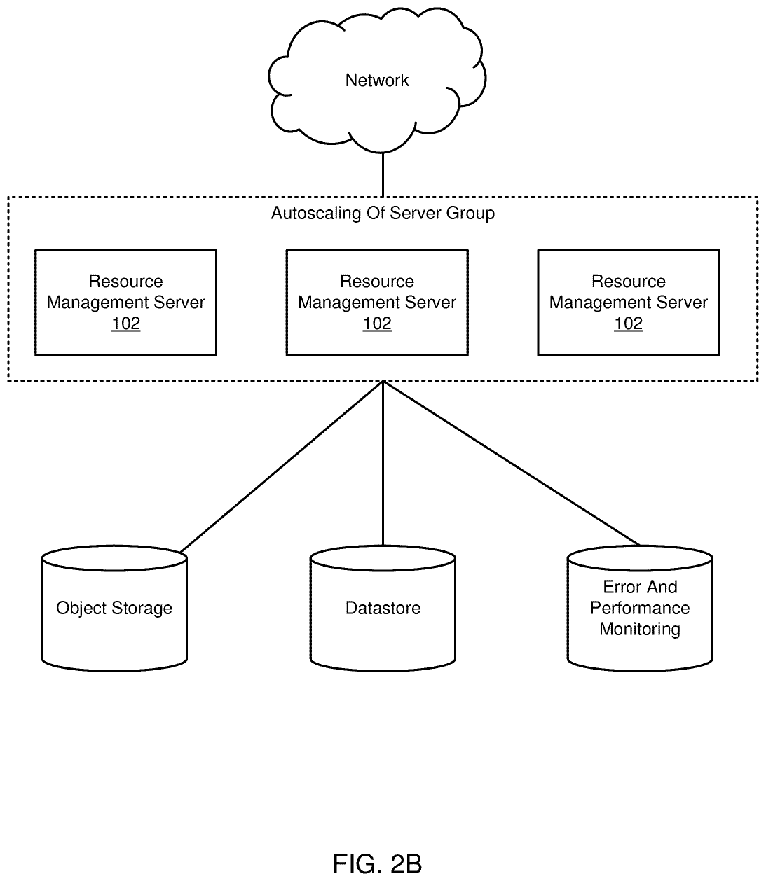

FIGS. 2A and 2B are schematic diagram of a system for data management and permissioned access to database entries. The systems described herein may be implemented in environments with sensitive data, and therefore, it can be imperative to ensure there is no crosstalk between customer or applicant accounts. This may be accomplished by partitioning client information across separate database instances that are located on different physical hardware. This may also be accomplished by assigning permissions to all data stored on the database 114 to ensure that only some users may have read and/or write access to certain data. The system includes a resource manager executed by the resource management server 102.

The resource management server 102 oversees data ingestion and data management for a plurality of client accounts, such as Customer Account A, Customer Account B, and Customer Account C. The resource management server 102 manages an execution platform that includes a plurality of processing nodes associated with the client accounts. The customer accounts may share the processing resources of the execution platform and/or may be assigned independent processing resources. FIG. 2A illustrates a plurality of processing nodes within the execution platform, including Processing Node A, Processing Node B, and Processing Node C.

The resource management server 102 manages the ingestion, normalization, organization, and storage of data entries within the storage resources. The storage resources include data entries pertaining to transactions associated with the client accounts. The customer accounts may have secure, permissioned access to data entries based on permissions metadata stored on the metadata store 116. The storage resources include data entries stored across a plurality of database instances, including, for example, Database Instance A, Database Instance B, and Database Instance C. It should be appreciated that the resource management server 102 may be in communication with any number of client accounts, processing nodes, and client database instances.

The storage resources store data in partitions that can be queried by the resource management server 102. In most cases, at least a portion of the data entries in the storage resources are immutable such that the entries cannot be deleted or modified and can only be replaced by storing a new, superseding data entry. Depending on the implementation, it is not always necessary or desirable that all data entries be immutable.

The network includes any type of network, such as a local area network, a wide area network, the Internet, a cellular communication network, or any combination of two or more communication networks. The resource management server 102 communicates with some client accounts and outside parties by way of communication protocols such as SWIFT MT (Society for Worldwide Interbank Financial Telecommunication Message Type) messages (such as MT 2XX, 5XX, 9XX), ISO 9022 (a standard for electronic data interchange between financial institutions), and proprietary application interfaces. The resource management server 102 ingests data and receives communications from client accounts (and entities associated with the client accounts) using secure APIs (Application Program Interfaces) and other protocols. The resource management server 102 can integrate with existing financial institutions, banks, clearinghouses, and exchanges without significant modification to the institution's systems.

The resource management server 102 determines whether a user is authorized, and what data that user is authorized to access. The resource management server 102 verifies the identity of each machine using security certificates and cryptographic keys. The resource management server 102 stores a listing of authorized users and roles, which may include actual users, systems, devices, or applications that are authorized to interact with the resource management server 102 and/or access certain data stored on the storage resources. The integrity of the system is provided using secure channels to communicate between the resource management server 102 and external systems. In some embodiments, communication between the resource management server 102 and external systems is performed using highly secure TLS (Transport Layer Security) with well-established handshakes between the resource management server 102 and the external systems. Implementations may use dedicated virtual private clouds (VPCs) for communication between the resource management server 102 and any external systems. Dedicated VPCs offer clients the ability to set up their own security and rules for accessing resource management server 102. In some situations, an external system or user may use the DirectConnect network service for better service-level agreements and security.

The resource management server 102 supports role-based access control of workflows and the actions associated with workflows. In some embodiments, users can customize a workflow to add custom steps to integrate with external systems. Additionally, system developers can develop custom workflows to support new business processes. In particular implementations, some of the actions performed by a workflow can be manual approvals, a SWIFT message request/response, scheduled or time-based actions, and the like. In some embodiments, roles can be assigned to users and access control lists can be applied to roles. An access control list controls access to actions and operations on entities within a network. This approach provides a hierarchical way of assigning privileges to users. A set of roles also include roles related to replication of data, which allows the resource management server 102 to identify what data can be replicated and who is the authorized user to be receiving the data at an external system.

The resource management platform 106 manages authentication of users. Authentication refers to how a user signs into the resource management platform 106 to access data within the database 114. The user must be authenticated as the root user or an Identity and Access Management (IAM) role. Additionally, a user may be assigned a tenant's single sign-on authentication. In these cases, an administrator previously set up identity federation using IAM roles. The resource management platform 106 manages root users, IAM users and groups, and service administrators. The resource management platform 106 provides cross-service access to some features with principal permissions, service roles, or service-linked roles.

The resource management platform 104 logically classifies data that is ingested from disparate sources and then partitions the data with assigned partitions across the multiple database instances. The resource management server 102 classifies data, controls user access, ensures privacy between users and their communications, and combines the data into an aggregated data package.

FIG. 2B is a schematic diagram of a system for data management and permissioned access to database entries, and the system illustrated in FIG. 2B may be implemented with structural components described in connection with FIG. 2A.

FIG. 2B illustrates wherein the resource management server 102 is serviced by a plurality of servers. This group of servers receives data inputs over a network connection. The data inputs are auto scaled across the plurality of instances of the resource management server 102 to reduce latency and improve system performance. The resource management server 102 then communicates with a plurality of storage resources for storing diverse types of data.

In an implementation, the resource management server 102 communicates with an object-based storage resource for storing objects. The resource management server 102 may further communicate with a relational database for managing a datastore. The resource management server 102 may additionally communicate with another storage resource when performing error and performance monitoring for managing and improving the resource management platform 106.

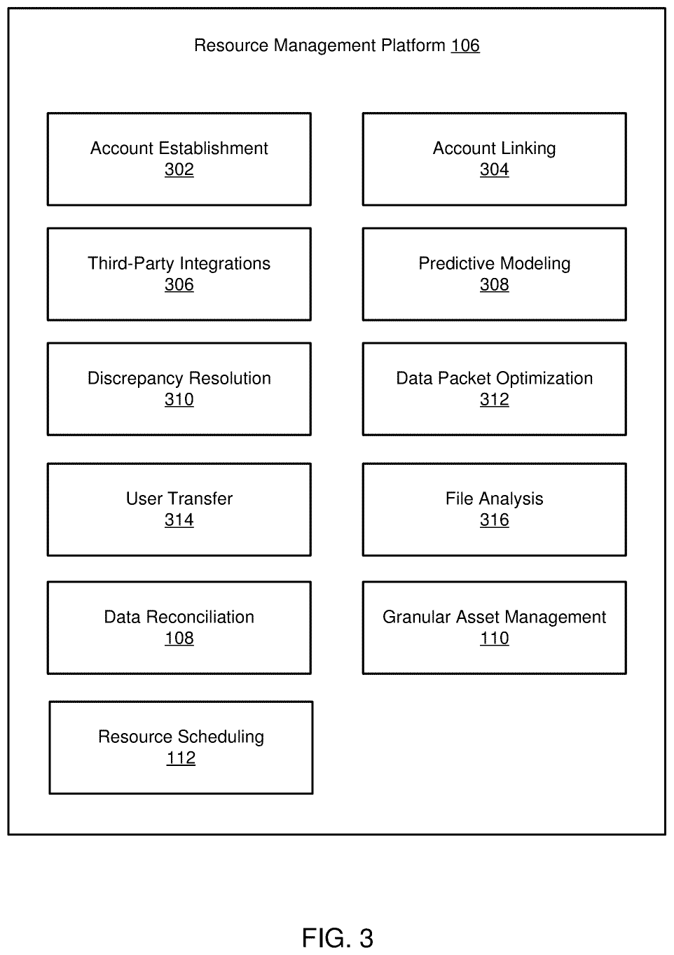

FIG. 3 is a schematic block diagram illustrating potential components of the resource management platform 106. The resource management platform 106 may include, for example, components and algorithms for account establishment 302, account linking 304, third-party integrations 306, predictive modeling 308, discrepancy resolution 310, data packet optimization 312, user transfer 314, file analysis 316, data reconciliation 108, granular asset management 110, and resource scheduling 112.

The account establishment 302 component is responsible for onboarding accounts within the resource management platform 106. Each account may be associated with a unique individual or entity. Different accounts will be assigned different permissions for accessing data stored on the database 114. The accounts may include, for example, administrator accounts with broader permissions to read and write data, and the accounts may include limited user accounts with limited permissions. Depending on the implementation of the resource management platform 106, the accounts may be specialized for certain tasks. For example, when the resource management platform 106 is implemented for project management, the accounts may include requester/client accounts, contractor accounts, supervisor accounts, employee accounts, management accounts, third-party integrated accounts, and so forth.

The account establishment 302 component generates a new account to be associated with a unique project and/or connects an existing account with the unique project. The resource management platform 106 will permit an account to read and/or write data associated with the unique project only if the account has been formally associated with the unique project by the account establishment 302 component.

The account linking 304 component associates accounts with a unique project and associates various datapoints with one another as needed, as explained further below. The account linking 304 component identifies a storage component of the database 114 (such as a table or grouping of tables) that are associated with the unique project. The account linking 304 component assigns permissions to the applicable accounts to access at least a portion of the data stored in the database 114 for the unique project. The account linking 304 component may independently assign read and write permissions to data stored on the database 114 for the unique project.

The account linking 304 component additionally links various datapoints together as needed. In an example implementation, the resource management platform 106 is used for managing various construction projects. In this implementation, it may be useful to link employees and/or contractors together to comply with safety protocols. For example, a first employee/contractor may be assigned to operate a piece of equipment and a second employee/contractor may be assigned to spot and monitor the first employee/contractor. In some cases, it may also be useful to link people together in a mentor/mentee relationship and ensure that those people move together when assigned to different jobsites, tasks, and projects. The account linking 304 component ties to individual profiles together and ensures that those two profiles are essentially viewed as one person within the resource management platform 106. In this case, the two linked individuals cannot be assigned to different jobsites or projects without first breaking the link and/or reassigning the individuals to different partnerships.

The third-party integrations 306 component establishes secure connections with third-party data sources. The third-party integrations 306 component stores a listing of authorized machines, devices, and accounts (i.e., “whitelisted”). The resource management server 102 securely communicates with outside parties by way of secure API access points. The third-party integrations 306 component may be implemented to receive real-time updates from various external parties or sensors. For example, the third-party integrations 306 component may track the real-time geographic location of equipment based on data received from a GPS system or owner of the equipment.

The predictive modeling 308 component analyzes data to identify trends applicable to projects and/or improves workflows executed by the resource management server 102. In an implementation, the resource management platform 106 presents a project to a machine learning algorithm trained to determine whether required equipment, tools, and supplies will be available for the project currently or in the future and whether sufficient labor will be available for the project currently or in the future.

The predictive modeling 308 component may include an analysis of variance (ANOVA) statistical model. ANOVA is a collection of statistical models and their associated estimation procedures used to analyze the differences among means. ANOVA is based on the law of total variance, where the observed variance in a particular variable is partitioned into components attributable to diverse sources of variation.

The predictive modeling 308 component may include a long short-term memory (LSTM) artificial neural network architecture. LSTM is an artificial recurrent neural network. Unlike standard feedforward neural networks, LSTM has feedback connection. The LSTM architecture can process single data points (such as images) and can further process sequences of data (such as speech or video). The LSTM architecture includes a cell, an input gate, an output gate, and a forget gate. The cell remembers values over arbitrary time intervals and the three gates regulate the flow of information into and out of the cell.

The predictive modeling 308 may include a recurrent neural network (RNN) architecture. The RNN architecture may be particularly implemented for modeling upcoming procedures and predicting future item usage based on past procedures. The RNN architecture is a class of artificial neural networks where connections between nodes form a directed graph along a temporal sequence. This allows the RNN to exhibit temporal dynamic behavior. RNNs can use an internal state (memory) to process variable length sequences of inputs.

The discrepancy resolution 310 component identifies discrepancies in the data stored on the database 114. The discrepancy resolution 310 component may be configured to identify discrepancies only within a single project. The discrepancy resolution 310 component may communicate with the file analysis 316 component to determine whether data manually input by a user conflicts with information presented in documents that have been uploaded by the user.

The data packet optimization 312 component reduces the size of data packets that must be transmitted to data sources 118. This may be particularly useful when a user is located in a remote location and does not have cellular or satellite service for an extended period or has limited bandwidth to download content. The data packet optimization 312 component creates a queue of documents and updates that need to be transmitted to a certain user account and received by a data source 118. The data packet optimization 312 component pares down the queue of documents to reduce the overall amount of data that must be received by the data source 118.

The user transfer 314 component assigns users (e.g., employees, contractors, craftsman, managers, and so forth) to certain projects, jobsites, and tasks. The user transfer 314 component additionally manages the assignment of equipment and tools to certain users, projects, and jobsites. The process of transferring users, equipment, and tools to different projects, jobsites, and tasks presents a technical problem pertaining to the manipulation and organization of data stored on the database 114.

In an example implementation, the resource management platform 106 is leveraged to manage various construction projects across different client accounts. In this implementation, numerous users are associated with the resource management platform 106, and these users need to be assigned to certain jobs on a certain date, including the present time and in the future. In some implementations, a user cannot be transferred to a different project until a manager or administrator has approved a transfer request. If a user needs to be transferred to a different project, and the user has a currently pending transfer request, then the currently pending transfer request must be rejected or cancelled before the user can be transferred. In some cases, a user should be transferred to another job only after the user has completed their current job.

The aforementioned technical problem is solved through the use of independent tables on the database 114 for each user or job. One table is generated to describe all persons working on a certain job over time. This table is assigned to one job, or one task within a job, and may be referred to herein as the user-job table. This job-user table includes columns indicating the start date and the end date for each user that worked on that job. If the end date is NULL, then the user is still on that job until transferred away. When a user needs to be transferred to a different job, the user transfer 314 component references the table to determine where the user is currently assigned, where the user will be assigned in the future, and when the user will be free. The user transfer 314 component ensures that users are not double-booked across multiple projects or jobsites on one day.

The file analysis 316 component analyzes files uploaded to the database 114 to determine the information depicted in those files. The files may include images, scans, videos, renders of digital documents, digital signatures, and so forth. The file analysis 316 component includes a neural network or machine learning algorithm configured to “read” a document and identify the information depicted in the document. The file analysis 316 component communicates with the discrepancy resolution 310 component to determine whether documents uploaded by an account are consistent with other data that has been manually-input or otherwise ingested for the account.

The file analysis 316 component includes a neural network for analyzing images uploaded to the resource management platform 106. The image analysis component performs facial recognition to identify if the same person is depicted in numerous images. The resource management platform 106 includes a means for an employee or contractor to “clock in” to work an indicate that they began a shift. The clocking-in process includes requiring the users to take a picture of themselves at the jobsite at the time they are checking in to work. The file analysis 316 component analyzes the check-in photograph to determine whether the person claiming to be clocking in is actually depicted in the photograph, and further to determine whether the person is actually located at the jobsite. The file analysis 316 component may further include analyzing the metadata associated with the photograph to ensure the person is actually located at the GPS coordinates for the jobsite.

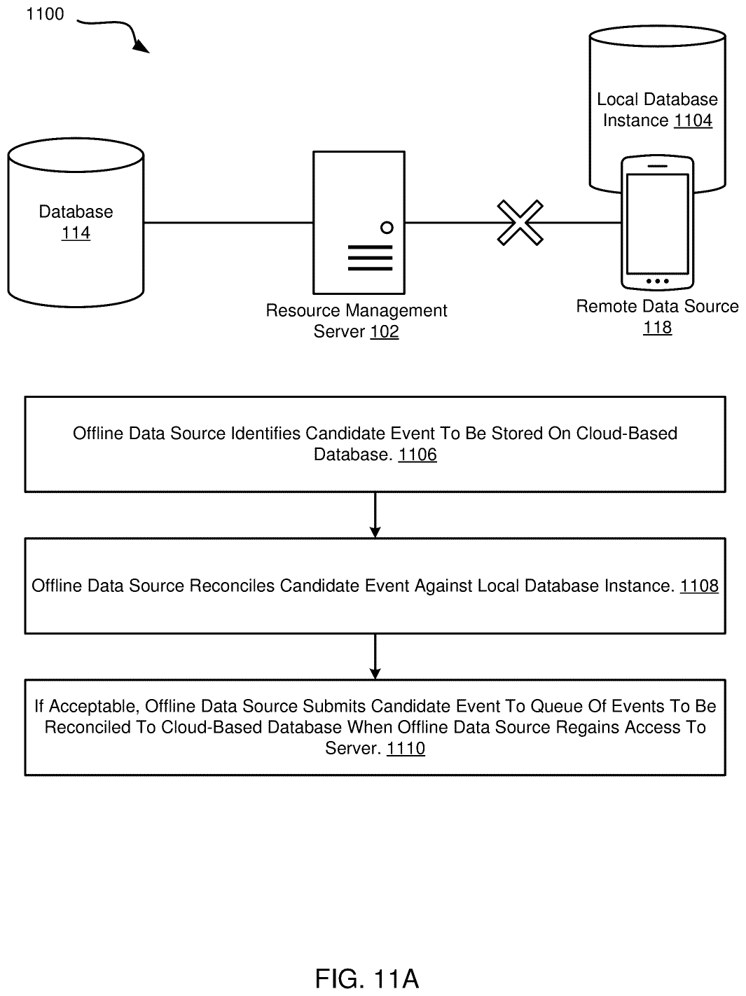

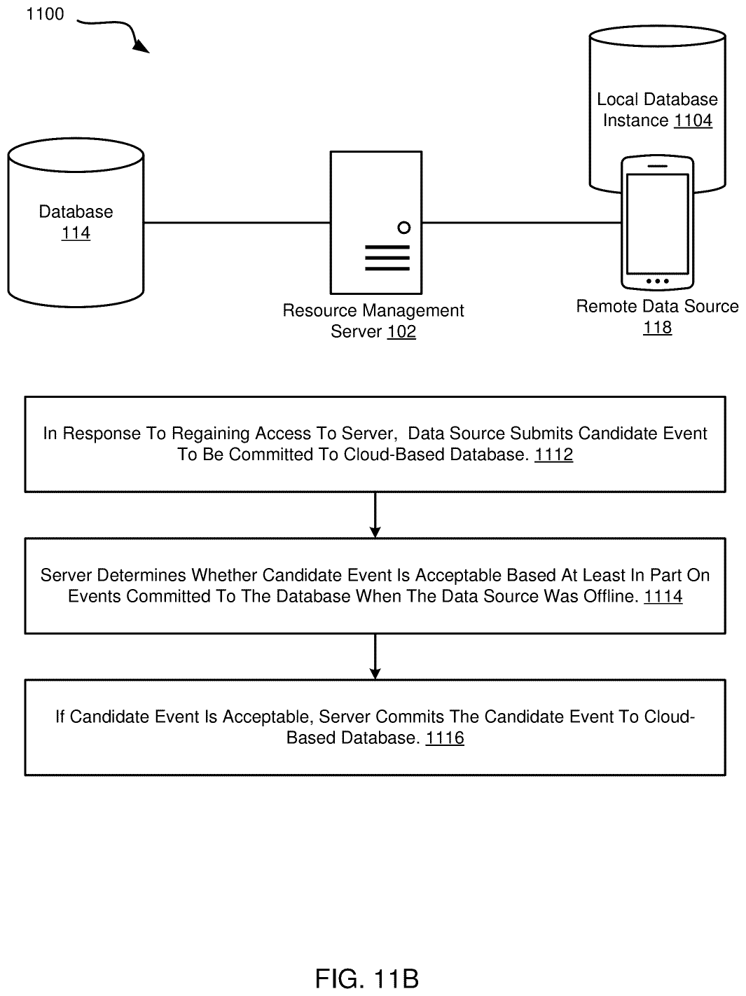

The data reconciliation 108 component compares conflicting data events and determines which data event should be stored on the database 114. The data reconciliation 108 component is particularly useful when a data event is generated by a remote data source 118 when the data source 118 was “offline” and did not have communicative access to a network and the cloud-based database 114. When the remote data source 118 comes back online, the remote data source 118 provides the data to the remote management server 102. The remote management server 102 then determines whether the data event conflicts with any data events currently stored on the database 114. The resource management server 102 determines whether the data event represents the most recent truth, and whether the data event should be committed to the database 114. The functionality of the data reconciliation 108 component is particularly discussed in connection with FIGS. 11A and 11B.

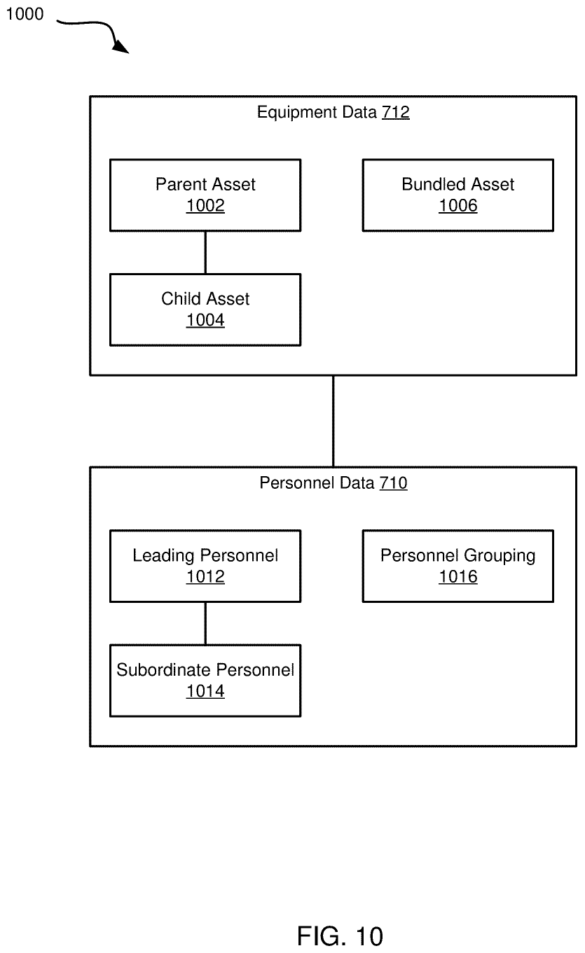

The granular asset management 110 component manages the organization of data and associations between datapoints for the database 114. The granular asset management 110 component may specifically manage asset management according to the data scheme discussed in connection with FIG. 10.

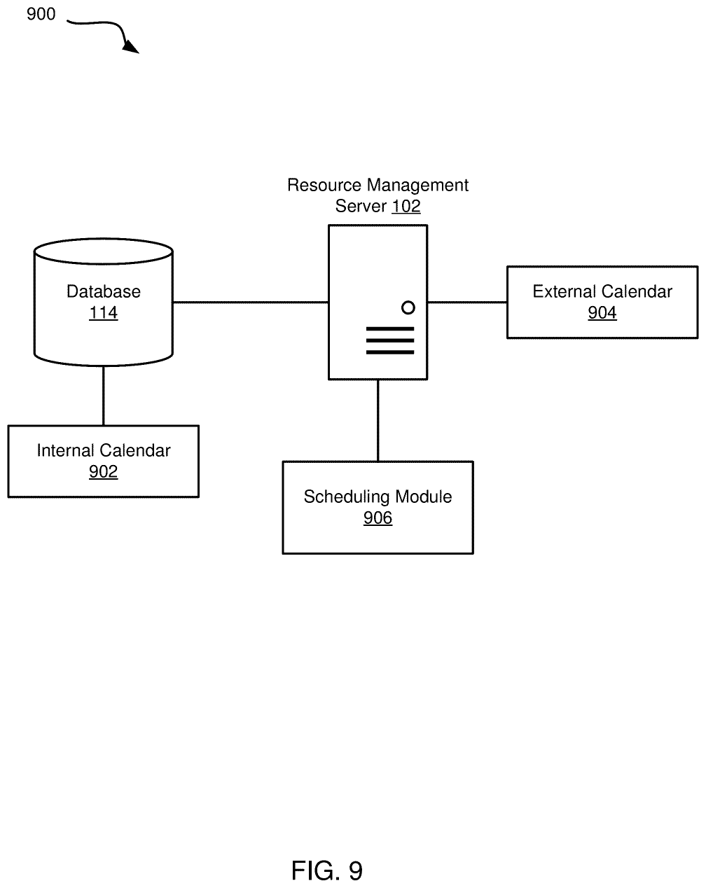

The resource scheduling 112 component manages the scheduling of personnel based on data extracted from internal and external calendars. The resource scheduling 112 component may specifically operate according to the disclosures presented in connection with FIG. 9.

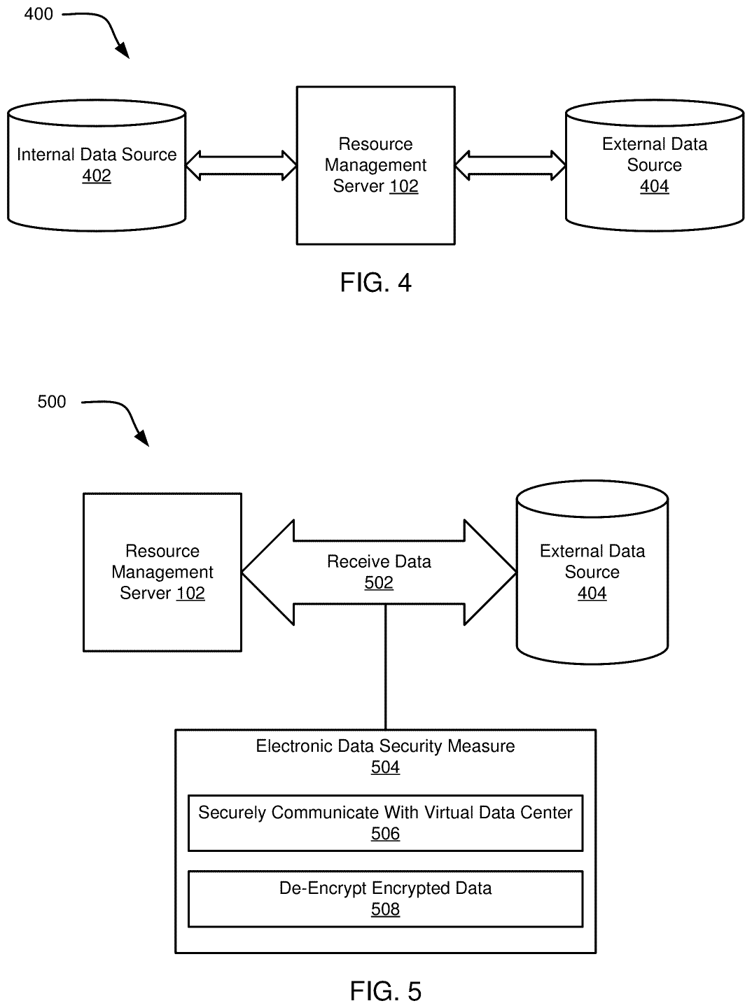

FIG. 4 is a schematic diagram of a system 400 for data communication between a resource management server 102 and internal and external data sources. The resource management server 102 may bidirectionally communicate with one or more of an internal data source 402 and an external data source 404. The resource management server 102 may receive confidential information, including personal identifying information, from outside sources, including directly from manual user input and from file transfer protocols from outside entities. The resource management server 102 may also provide confidential information to outside parties.

In an embodiment, the resource management server 102 communicates directly with an external data source 404 that is managed or owned by a third-party entity. The resource management server 102 may communicate by way of SSL-encrypted HTTP connections. In an embodiment, the external data source 404 is a relational database, and the resource management server 102 communicates with the relational database by way of an Application Program Interface (API). In an embodiment, the external data source 404 is an encrypted hard drive that has been shared with the resource management server 102. In an embodiment, the external data source 404 is a virtual data center, and the resource management server 102 access the data on a virtual server after signing in or undergoing some other authentication step.

In an embodiment, the resource management server 102 communicates with an internal data source 402 that is not managed by some other third-party entity. The internal data source 402 may include a file that has been downloaded or otherwise received from some third-party entity. After the file has been downloaded, the file can be managed and manipulated by the resource management server 102. The internal data source 402 may include an encrypted hard drive that is provided by a third-party.

FIG. 5 is a schematic diagram of a system and method 500 for performing electronic data security measures on data received from the external data source 404. In some cases, the data may be private or encrypted, such as item-use data for procedures that were performed in the past.

In an embodiment, the resource management server 102 receives data 502 by securely communicating with a virtual data center. The protocol for receiving the data 502 from the external data source 404 involves electronic data security measures 504. In an embodiment, an account may be created for a user associated with the resource management server 102, and the user could sign into the virtual data center with the account. The user could then access the data stored in the virtual data center by way of the account (see 506). The data may be encrypted or non-encrypted based on the security measures of the virtual data center. In an embodiment, the data may be non-encrypted when viewed by way of a network connection, and the data may be encrypted if downloaded for offline use and manipulation. If the data is downloaded in an encrypted form, then the data must be de-encrypted prior to analysis and manipulation (see 508).

In an embodiment, the resource management server 102 receives data by way of an encrypted hard drive. The encrypted hard drive may be provided by the source of the data. In an embodiment, the resource management server 102 receives claims data by way of an encrypted file that has been downloaded by way of a network connection. The resource management server 102 undergoes an electronic data security measure 404 by de-encrypting the claims data.

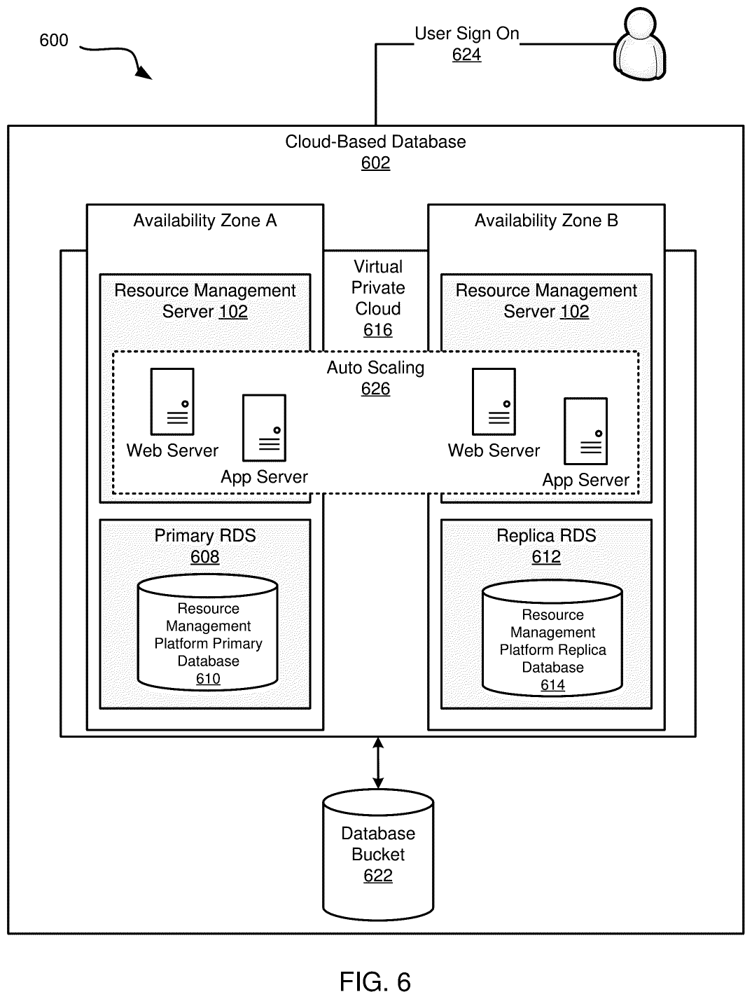

FIG. 6 is a schematic block diagram of a system 600 for data management and security. The system 600 illustrated in FIG. 6 may be implemented in conjunction with the system 100 illustrated in FIG. 1. The system 600 includes a cloud-based database 602 supporting the resource management server 102. The cloud-based database 602 includes an Availability Zone A and an Availability Zone B. The Availability Zone A includes a first instance of the resource management server 102 and the Availability Zone B includes another instance of the resource management server 102. Each of the instances of the resource management server 102 includes a web server and an app server, and the cloud-based database 602 auto-scales the processing and storage resources between the web servers and app servers for the Availability Zone A and the Availability Zone B. The Availability Zone A includes a primary relational database service (RDS) 608 and the Availability Zone B includes a replica relational database service 612. The resource management platform primary database 610 is stored on the primary relational database service 608 and the resource management platform replica database 614 is stored on the replica relational database service 612. The virtual private cloud 616 of the cloud-based database 602 communicates with outside parties by way of Application Program Interfaces 618 and Secure File Transfer Protocol (SFTP) 620 messaging. The cloud-based database 602 includes a database bucket 622 for storing information associated with the resource management platform 106. Users interacting the resource management platform 106 can sign on 624 to the service by communicating with the cloud-based database 602.

The cloud-based database 602 includes processing and storage resources in communication with the network. The cloud-based database 602 includes a resource manager for managing the usage of processing and storage resources. The resource manager of the cloud-based database 602 performs auto scaling 626 load balancing to ensure adequate processing and storage resources are available on demand based on real-time usage.

The availability zones represent discrete datacenters with redundant power, networking, and connectivity for supporting the resource management server 102. The availability zones enable the ability to operate production applications and databases in a more available, fault tolerant, and scalable way than would be possible with a single datacenter. The Availability Zone A and Availability Zone B are interconnected with high-bandwidth, low-latency networking, over fully redundant, dedicated metro fiber providing high-throughput, low-latency networking between the availability zones. All traffic between the availability zones is encrypted. The network performance of the availability zones is sufficient to accomplish synchronous replication between the availability zones. Applications, modules, components, and processing methods can be partitioned between the availability zones of the cloud-based database 602. When applications are partitioned across the availability zones, the resource management server 102 operates with increased protection and isolation from outages that may be caused by a low in power, hardware issues, software issues, and so forth. The availability zones are physically separated by a meaningful geographic distance to ensure the hardware supporting the availability zones will not be impacted by the same outside forces, such as power outages, natural disasters, and so forth.

The virtual private cloud 616 is an on-demand configurable pool of shared resources allocated within the cloud-based database 602. The virtual private cloud 616 provides isolation between different users communicating with the cloud-based database 602, e.g., different facilities, user accounts, and clients in communication with the resource management platform 106. The isolation between one virtual private cloud 616 user and all other users of the same cloud is achieved through allocation of a private IP subnet and a virtual communication construction such as a VLAN or a set of encrypted communication channels per user. The virtual private cloud 616 provides isolation between users within the cloud-based database 602 and is accompanied with a VPN function allocated per-user within the virtual private cloud 616. This secures the remote access to the resource management platform 106 by way of authentication and encryption. The resource management platform 106 is then essential run on a “virtually private” cloud, even if the processing and storage resources are provided by a third-party cloud-based database service.

The auto-scaling 626 is performed by a resource manager of the cloud-based database 602. The resource manager distributes workload between the web servers and the app servers of the various availability zones of the cloud-based database 602. In some cases, one client of the resource management platform 106 may consume a large quantity of storage resources and processing resources at a certain time, and the resource manager will allocate different web servers and app servers across the availability zones to ensure the client receives an adequate quantity of storage and processing resources. The auto-scaling 626 is performed in real-time to meet the needs of the resource management platform 106.

The primary and secondary relational database services 608, 612 provide a means to access, replicate, query, and write to the resource management platform database instances 610, 614. The resource management platform primary database 610 may include a copy of data associated with the resource management platform 106, such as user login information, user preference data, pharmaceutical inventory data, past purchasing data, current pricing data, pharmaceutical catalogue data, and so forth. The resource management platform replica database 614 may include a replica copy of all or some of the data stored on the resource management platform primary database 610. The replicated databases provide fault-tolerance and protect the resource management platform 106 form becoming inoperative during a power outage, hardware outage, or natural disaster.

The database bucket 622 provides object storage through a web service interface. The database bucket 622 uses scalable storage infrastructure that can be employed to store any type of object. The database bucket 622 may store applications, software code, backup and recovery, disaster recovery, data archives, data lakes for analytics, and hybrid cloud storage to support the resource management platform 106.

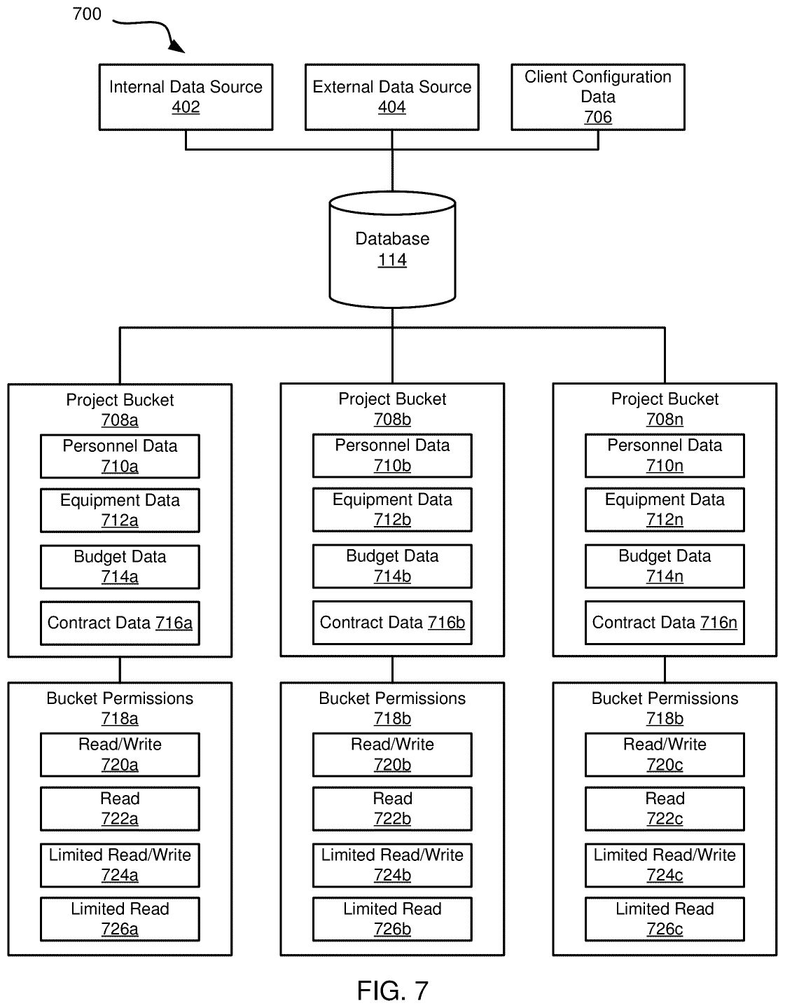

FIG. 7 is a schematic diagram of a system 700 for aggregating data from a plurality of disparate sources and then assigning the aggregated data to different project buckets on a database. The system 700 additionally includes parameters for assigning unique permissions to data within the data buckets. As described in connection with FIG. 1, data may be retrieved and aggregated from a plurality of different sources, including data sources 118 associated with both internal data sources 402 (e.g., clients and users of the resource management platform 106) and external data sources 404 (e.g., outside entities providing information pertaining to the users of the resource management platform 106). Data may additionally be retrieved or scraped from third-party communication clients 108 and data may be output from an AI/ML engine 104. The resource management server 102 ingests data from a plurality of disparate sources, normalizes the data, and partitions the data into appropriate tables within the database 114.

The database 114 stores data retrieved from internal data sources 402, which may include users of the resource management platform 106. The internal data sources 402 may provide user inputs, including, for example, a user creating a new project, a user inputting timecard entries, a user inputting equipment checks or verifications, a user submitting GPS data, and so forth. The database 114 additionally stores data retrieved from external data sources 402, which may include outside entities that are not directly associated with the resource management platform 106. External data sources 404 may include, for example, equipment rental companies providing equipment rentals to users associated with the resource management platform 106, invoicing or billing companies associated with users of the resource management platform 106, customers of the users of the resource management platform 106, and so forth. The database 114 also stores client configuration data 706, which may include, for example, manually input client specifications or preferences for how projects, personnel, equipment, tools, and so forth should be managed by each client associated with the resource management platform 106.

The database 114 partitions data into different project buckets 708, wherein each project bucket is associated with a project comprising one or more tasks. In an example implementation, a client of the resource management platform 106 instructs the resource management server 102 to create a project bucket 708 to represent a real-world construction project, such as the construction of a building, highway, installation of public utilities, maintenance of existing utilities, and so forth. The resource management server 102 creates a project bucket 708 to be stored on the database 114 to organize all known data associated with the real-world construction project. The project bucket 708 will store a variety of information that is organized in a time-based longitudinal data format. This information may include, for example, personnel data 710, equipment data 712, budget data 714, contract data 716, and so forth.

In the example system 700 illustrated in FIG. 7, the database 114 is storing three separate project buckets 708a, 708b, 708n, but it should be appreciated that the database 114 may store any number of project buckets as needed. The first project bucket 708a includes personnel data 710a, equipment data 712a, budget data 714, contract data 716a, and so forth. The second project bucket 708b stores personnel data 710b, equipment data 712b, budget data 714b, contract data 716b, and so forth. Each project budget 708 will store its own copy of unique data.

The various project buckets 708 may be distributed across different bare metal servers which may be located in different geographic regions. In some cases, each project budget 708 is replicated across different physical database resources located in different geographic regions, as discussed in connection with FIG. 6. Each project bucket 708 is associated with at least one client account on the resource management platform 106.

The project buckets 708 may be implemented with different database schemas and data formats. In an example implementation, each project bucket 708 is represented in one or more tables on a relational database. In some cases, each project bucket 708 includes multiple independent tables. For example, the project bucket 708 may include a primary table that maps to multiple dependent tables, including, for example, independent dependent tables for the personnel data 710, equipment data 712, budget data 714, contract data 716, and so forth.

The database 114 manages bucket permissions 718 for each project bucket 708 and for the data stored on each project bucket 710-716. Different users of the resource management platform 106 will have different read and write permissions for several types of data. In an example implementation, a supervisor on a construction job has broad read and write permissions to view and amend distinct types of data stored within a first project bucket 708 associated with a first project but has zero read and write permissions for data stored on a second project bucket 708 associated with a second project. Further to the example implementation, a worker or contractor reporting into the supervisor may have highly limited read and write permissions within the project bucket 708. The worker may be allowed to read data associated with schedules, contracts, timelines, equipment, and so forth associated with the project, but may have highly restricted “write” access to changing the data stored in the project bucket 708.

Specifically, the database 114 assigns bucket permissions 718 to each project bucket 708 that include read and write permissions 720, read-only permissions 722, limited read and write permissions 724, and limited read-only permissions 726. The read and write permissions 720 and the read-only permissions 722 apply to all data within the project bucket 708. The limited read and write permissions 724 and limited read-only permissions 726 may be applied to only certain data within the project bucket 708 such as, for example, only one or more of personnel data 710, equipment data 712, budget data 714, or contract data 716.

In an implementation, there is one or more administrators assigned to each project bucket 708, and different administrators may be assigned to different project buckets 708. The one or more administrators typically have read and write permissions 720 for all data within the project bucket 708, but this setting can be adjusted as needed. Further in this implementation, there may additionally be one or more users assigned limited read and write permissions 724 to the project bucket 708. For example, a user in charge of managing the whereabouts of equipment might be assigned read and write permissions 724 only to the equipment data 712. In another example, a user in charge of managing a certain group of personnel might be assigned limited read and write permissions 724 to only a portion of the personnel data 710 or all personnel data 710.

The bucket permissions 718 may be implemented to provide different permissions to general contractors, subcontractors, outside parties, independent inspectors, government agencies, and so forth. In an example implementation, a general contractor overseeing an entire project is granted read and write permissions 720 to all data within the project bucket 708. A subcontractor assigned to complete electrical work for the project may be assigned limited read and write permissions 724 only to personnel data 710, equipment data 712, budget data 714, and/or contract data 716 associated with applicable electrical work. Further for example, an independent inspector on the project might be assigned read permissions 722 to all data associated with the project bucket 708 to verify that data submitted into the project bucket 708 matches real-world realities. Further for example, a government agency or inspector might be assigned limited read permissions 726 to certain data within the project bucket 708, and this data might change over time. For example, the government inspector might be assigned limited read permissions 726 to view data associated with only those projects that the government inspector is scheduled to inspect within a threshold amount of time.

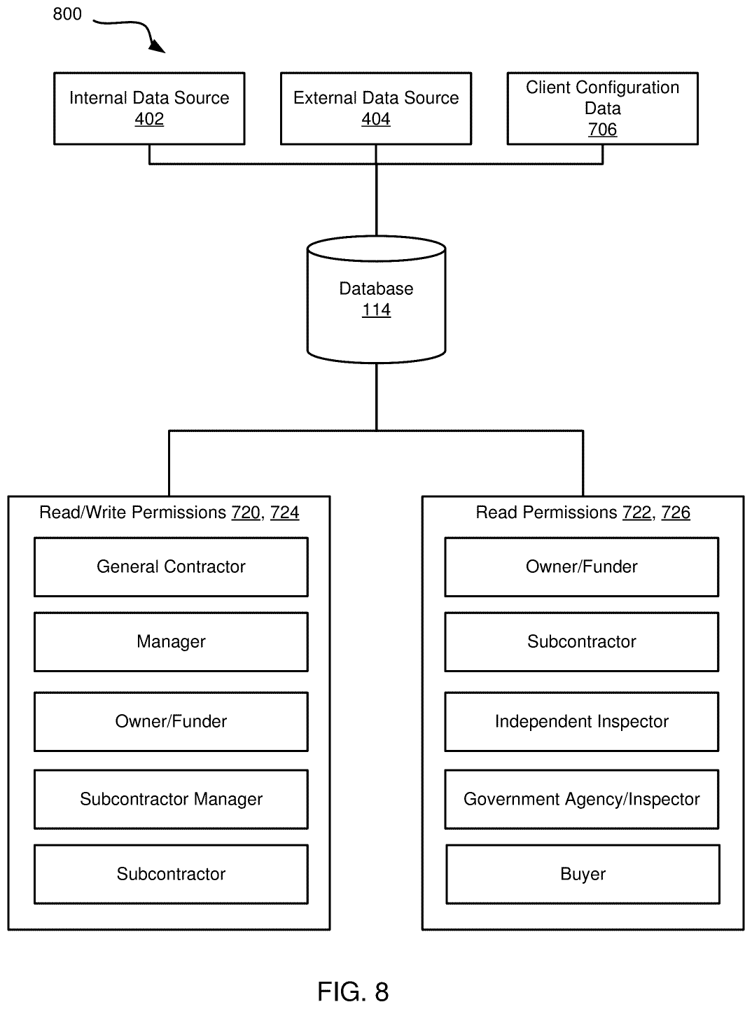

FIG. 8 is a schematic block diagram of an example data permissions configuration 800 for enabling collaboration on database 114 data. The example configuration 800 is implemented within the system 700 discussed in connection with FIG. 7, and specifically provides an example implementation of the read/write permissions 720, read-only permissions, limited read/write permissions 724, and limited read-only permissions 726 discussed in connection with FIG. 7.

In an example implementation, multiple users have permissions to access data stored on the database 114. These users may include managers or owners of a project associated with a project bucket 708 and may additionally include outside parties and other collaborators. Each of these users may be assigned different permissions 720-726 to different project buckets 708 on the database 114 and different data tables or data types within those project buckets 708. The user permissions are implemented with a high degree of granularity to ensure the integrity of the data.

In the example implementation illustrated in FIG. 8, the data stored on the database 114 applies to a construction project, such as, for example, a commercial real estate construction project, a machinery manufacturing project, a transportation construction project such as building a roadway, bridge, overpass, and so forth, a landscaping construction project, a residential real estate construction project, and so forth. Each of these construction projects may be implemented in the real world with a series of persons, including general contractors, contractors, independent inspectors, government agencies and inspectors, and so forth. Additionally, other persons may wish to collaborate on the project without directly impacting the project, and these individuals could include, for example, the owner or funder of the project, the intended buyer of the project, the general public, and so forth. Each of these individuals may be assigned highly granular permissions to data stored on the database 114.

In an example implementation, an independent inspector is assigned read-only permissions 722, 726 to all data within a project bucket 708 or a portion of the data within a project bucket 708. The independent inspector may then watch the construction project in the real-world and verify that data being input into the project bucket 708 reflects realities in the real-world. The independent inspector might be prohibited from editing any data within the project bucket 708.

FIG. 9 is a schematic block diagram of an example system 900 for managing scheduling within a resource management platform 106. The scheduling functionalities described herein might be implemented when the resource management platform 106 is utilized to manage the execution of a project, such as a construction or manufacturing project.

The system 900 includes the resource management server 102 in communication with the database 114. The database 114 itself may store an internal calendar 902 for the resource management platform 106. The internal calendar 902 may be rendered on a user interface as a component of the resource management platform 106. The system 900 further includes one or more external calendars 904 in communication with the resource management server 102. The resource management server 102 may receive data from the external calendar 904 by way of an application program interface (API) or other suitable means. Typically, an owner of the external calendar will grant special permissions 904 that enables the resource management server 102 to read data updated to the external calendar 904. The system 900 further includes a scheduling module 906 executed by the resource management server 102.

The internal calendar 902 includes data pertaining to the anticipated schedules for users within the resource management platform 106. The internal calendar 902 includes, for example, the anticipated availability of users, and the anticipated tasks to be performed by users, including when and where those tasks will be performed. The internal calendar 902 additionally includes data pertaining to the progress of a project. The internal calendar 902 may indicate when certain tasks will likely be completed, and when other subsequent tasks should be scheduled. For example, the internal calendar 902 may assess the projected schedules of users within the resource management platform 106 to calculate a projected completion date for certain tasks like electrical, plumbing, drywall, flooring, and so forth.

The external calendar 904 includes data managed by digital calendars that are not managed by the resource management server 102. This may include personal calendars, work calendars, and enterprise-wide calendars for external entities that engage with the resource management server 102. In an example implementation, a subcontractor provides the resource management server 102 with read-only access to its external calendar 904 that includes the anticipated availability of one or more individuals working for the subcontractor. The resource management server 102 may then view the subcontractor's external calendar 904 and determine when the subcontractor may be scheduled to complete a task for a project that is managed by the resource management platform 106.

The scheduling module 906 is configured to automatically track data within the internal calendar 902 and the external calendar 904 and make determinations based on that data. Specifically, the scheduling module 906 is configured to project when a certain task or project will be completed based on data from the internal calendar 902 and/or the external calendar 904. The scheduling module 906 performs this based on the projected availability and/or scheduled tasks for individuals who will be performing work on the project.

Additionally, the scheduling module 906 is configured to recommend when certain individuals/entities can be scheduled to complete a task and/or automatically schedule those individuals/entities to complete the task. The scheduling module 906 does this by tracking when a certain task should be executed based on current data provided to the database 114. For example, the scheduling module 906 may be programmed with a rule to understand that drywall work will be performed after an inspection has been passed. The scheduling module 906 may determine that the inspection has been passed and may then automatically look to the internal calendar 902 and/or the external calendar 904 for drywall subcontractors. Based on the availability of the drywall subcontractors (based on data within the internal calendar 902 and external calendar 904), the scheduling module 906 may automatically attempt to schedule available drywall subcontractors and/or provide a notification to a user that the drywall subcontractors should be scheduled.

Data from the internal calendar 902 may additionally be provided to outside parties to notify those parties when their services will be needed. In an example implementation, the internal calendar 902 includes a schedule of when certain tasks will be performed on the project. An outside party, such as a plumbing subcontractor, may view the internal calendar 902 (using read-only permissions 722, 726 as discussed in FIGS. 7-8) to determine that a certain quantity of plumbers will be needed at the project during a certain date range.

The scheduling module 906 is additionally configured to cause certain equipment or personnel to be rendered unavailable on the resource management platform 106 in response to determining that equipment or personnel is currently in use or currently scheduled at a certain location. In an example implementation, the scheduling module 906 determines that a user or personnel is currently located at a certain location and is predicted to be located at that location for a certain duration of time. The scheduling module 906 notifies the resource management server 102 that the user/personnel should be classified as currently unavailable across all other projects and clients on the resource management platform 106. The scheduling module 906 may render the user/personnel unavailable at future times as well based on the user/personnel's calendar data 902, 904. Similarly, the scheduling module 906 renders certain equipment unavailable based on the equipment's current location and future schedule.

FIG. 10 is a schematic block diagram of an example data schema 1000 for managing data within a project bucket 708. Data stored on the database 114 is managed to a granular level, and certain datapoints may be matched or associated with other data points.

Specifically, equipment data 712 can be matched, paired with, or otherwise associated with personnel data 710. This may be particularly useful when attempting to assign a certain piece of equipment to an individual, entity, or group of individuals.

The equipment data 712 is managed on a granular level based on the type of equipment, the permissions typically associated with the equipment, and whether multiple equipment pieces should be tied to one another. In some cases, the equipment data 712 establishes a parent/child relationship between multiple pieces of equipment. In an example implementation, a parent asset 1002 might include a truck, and an associated child asset 1004 might include a tool set that remains with the truck at all times. In this case, the parent asset 1002 and the child asset 1004 constitute separate assets but should be associated with each other to aid in tracking the assets' whereabouts in the real world.

The equipment data 712 additionally includes bundled assets 1006 that can be adjusted in real-time based on changing conditions. In an example implementation, a bundled asset 1006 includes a grouping of traffic cones, wherein each individual traffic cone might have little value as a datapoint, but a bundle of many traffic cones is important to track. The quantity of traffic cones within the bundled asset 1006 is adjusted when new traffic cones are added to the bundle and when traffic cones are lost or damaged and then removed from the bundle. Thus, this bundled asset 10065 includes a descriptor (i.e., traffic cones) and an adjustable quantity that reflects real-world conditions. This obviates the need to individually track the whereabouts, condition, and assignments of each of the traffic cones, and instead enables each traffic cone within a bundle to be tracked as a group.

The personnel data 710 is similarly organized to reflect parent/child relationships. In the context of personnel data 710, a leading personnel 1012 might include a manager or supervisor, and a subordinate personnel 1014 might include an employee or contractor that reports into the leading personnel 1012. These relationships can be useful to track when seeking to determine who is ultimately responsible for tracking equipment, completing a task, signing off on time entries, and so forth. Additionally, personnel data 710 may include a personnel grouping 1016. The personnel grouping 1016 is similar to the bundled asset 1006 in that the datapoint will include a descriptor (e.g., plumbers, electricians, flooring contracts, etc.) and a quantity. The quantity of available personnel within that personnel grouping 1016 may adjust over time based on scheduling and need. The quantity of personnel within the personnel grouping 1016 may be adjusted based on outputs from the scheduling module 906. In an example implementation, a personnel grouping 1016 is established for available electricians, and the quantity of available electricians will be adjusted based on outputs from the internal calendar 902 and/or the external calendar 904.

Data points within the personnel data 710 may be matched or paired with datapoints within the equipment data 712. This is particularly useful when seeking to assign responsibility for equipment to a certain individual, entity, or group of individuals. These data groupings may be executed on a granular level such that, for example, a certain bundled asset 1006 is assigned to a certain subordinate personnel 1014 and is thereby additionally (and sometimes automatically) assigned to the applicable leading personnel 1012 as well.

FIGS. 11A and 11B are schematic diagrams of a system and process flow 1100 for data ingestion and reconciliation. The process flow 1100 is executed when a remote data source 118 does not have communicative access to the resource management server 102. This may commonly occur when the data source 118 is offline and is not within range of a hardwired or wireless network connection.

The process flow 1100 occurs when the data source 118 is offline. The offline data source identifies at 1106 a candidate event to be stored on the database 114. This process may be performed by an application running on the data source. The application may render an instance of the resource management platform 106, and a user may interact with a graphical user interface of the resource management platform 106 to input the data event. The candidate event may include, for example, data pertaining to progress of a task or project, data pertaining to the location, schedule, or condition of equipment, data pertaining to the location, schedule, and status of personnel, and so forth. The candidate event may include, for example, a “clock-in” or “clock-out” timestamp event for personnel. The candidate event may include a communication to be provided to one or more other users interacting with the resource management platform 106. It should be appreciated that the candidate event may include any suitable data event and may specifically include any suitable data event as described herein in relation to a project management platform.

The process flow 1100 continues and the data source 118 reconciles the candidate event against a local database instance 1104 stored on the data source 118. The local database instance 1104 is a copy of at least a portion of the data stored on the cloud-based database 114. The local database instance 1104 is utilized by the data source 118 particularly when the data source 118 is offline and does not have real-time communicative access to the resource management server 102.

The process flow 1100 continues and the data source 118 determines whether the candidate event is acceptable. The candidate event may be acceptable if the candidate event is current, approved by a user, and/or does not contradict information stored on the local database instance 1104. If the candidate event is acceptable, then the data source 118 submits at 1110 the candidate event to a queue of events to be reconciled to the cloud-based database 114 when the data source 118 regains access to the resource management server 102.

The process flow 1100 continues at FIG. 11B with the data source 118 regaining real-time access to communicate with the resource management server 102. The data source 118 submits at 1112 the candidate event to be committed to the cloud-based database 114. The resource management server 102 determines at 1114 whether the candidate event is acceptable based at least in part on events committed to the database 114 when the data source 118 was offline. If the resource management server 102 determines the candidate event is acceptable, then the resource management server 102 commits the candidate event to the cloud-based database 114.

The resource management server 102 executes a rules-based engine to determine whether the candidate event is acceptable, and whether the candidate should be stored on the database 114 as the record of truth. The resource management server 102 may execute different instructions to determine acceptability depending on what type of data point is submitted by the data source 118.

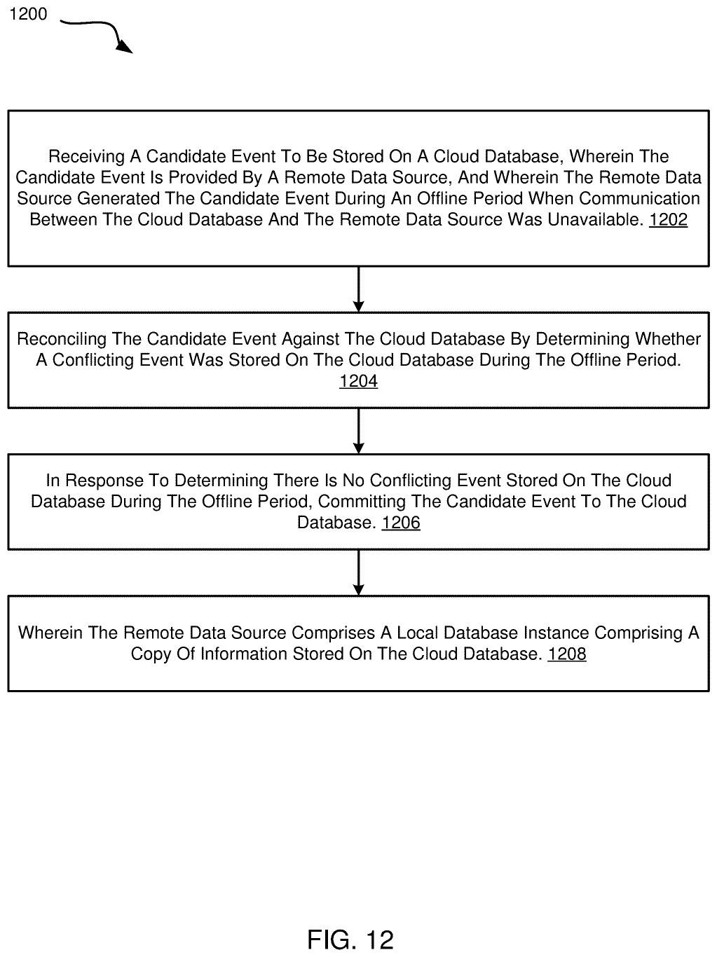

FIG. 12 is a schematic flow chart diagram of a method 1200 for data ingestion and reconciliation across multiple computing devices. The method 1200 includes receiving at 1202 a candidate event to be stored on a cloud database, wherein the candidate event is provided by a remote data source, and wherein the remote data source generated the candidate event during an offline period when communication between the cloud database and the remote data source was unavailable. The method 1200 includes reconciling at 1204 the candidate event against the cloud database by determining whether a conflicting event was stored on the cloud database during the offline period. The method 1200 includes, in response to determining there is no conflicting event stored on the cloud database during the offline period, committing at 1206 the candidate event to the cloud database. The method 1200 is such that the remote data source comprises a local database instance comprising a copy of information stored on the cloud database (see 1208).

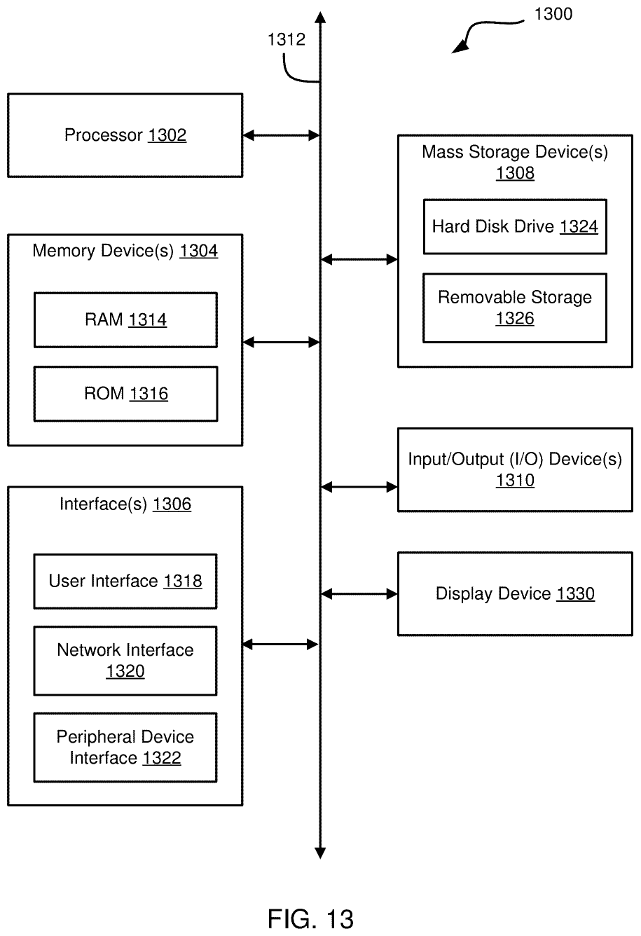

Referring now to FIG. 13, a block diagram of an example computing device 1300 is illustrated. Computing device 1300 may be used to perform various procedures, such as those discussed herein. Computing device 1300 can perform various monitoring functions as discussed herein, and can execute one or more application programs, such as the application programs or functionality described herein. Computing device 1300 can be any of a wide variety of computing devices, such as a desktop computer, in-dash computer, vehicle control system, a notebook computer, a server computer, a handheld computer, tablet computer and the like.

Computing device 1300 includes one or more processor(s) 1302, one or more memory device(s) 1304, one or more interface(s) 1306, one or more mass storage device(s) 1308, one or more Input/output (I/O) device(s) 1310, and a display device 1330 all of which are coupled to a bus 1312. Processor(s) 1302 include one or more processors or controllers that execute instructions stored in memory device(s) 1304 and/or mass storage device(s) 1308. Processor(s) 1302 may also include diverse types of computer-readable media, such as cache memory.

Memory device(s) 1304 include various computer-readable media, such as volatile memory (e.g., random access memory (RAM) 1314) and/or nonvolatile memory (e.g., read-only memory (ROM) 1316). Memory device(s) 1304 may also include rewritable ROM, such as Flash memory.

Mass storage device(s) 1308 include various computer readable media, such as magnetic tapes, magnetic disks, optical disks, solid-state memory (e.g., Flash memory), and so forth. As shown in FIG. 13, a particular mass storage device 1308 is a hard disk drive 1324. Various drives may also be included in mass storage device(s) 1308 to enable reading from and/or writing to the various computer readable media. Mass storage device(s) 1308 include removable media 1326 and/or non-removable media.

I/O device(s) 1310 include various devices that allow data and/or other information to be input to or retrieved from computing device 1300. Example I/O device(s) 1310 include cursor control devices, keyboards, keypads, microphones, monitors or other display devices, speakers, printers, network interface cards, modems, barcode scanners, and the like.

Display device 1330 includes any type of device capable of displaying information to one or more users of computing device 1300. Examples of display device 1330 include a monitor, display terminal, video projection device, and the like.

Interface(s) 1306 include various interfaces that allow computing device 1300 to interact with other systems, devices, or computing environments. Example interface(s) 1306 may include any number of different network interfaces 1320, such as interfaces to local area networks (LANs), wide area networks (WANs), wireless networks, and the Internet. Other interface(s) include user interface 1318 and peripheral device interface 1322. The interface(s) 1306 may also include one or more user interface elements 1318. The interface(s) 1306 may also include one or more peripheral interfaces 1322 such as interfaces for printers, pointing devices (mice, track pad, or any suitable user interface now known to those of ordinary skill in the field, or later discovered), keyboards, and the like.

Bus 1312 allows processor(s) 1302, memory device(s) 1304, interface(s) 1306, mass storage device(s) 1308, and I/O device(s) 1310 to communicate with one another, as well as other devices or components coupled to bus 1312. Bus 1312 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 900 and are executed by processor(s) 902. Alternatively, the systems and procedures described herein can be implemented in hardware, or a combination of hardware, software, and/or firmware. For example, one or more application specific integrated circuits (ASICs) can be programmed to conduct one or more of the systems and procedures described herein.

### Examples

The following examples pertain to further embodiments.

Example 1 is a method. The method includes identifying a project task to be executed. The method includes identifying a personnel-type to execute the project task. The method includes extracting data from a calendar to determine when one or more personnel of the personnel-type is available to execute the project task.

Example 2 is a method as in Example 1, further including extracting information from an external calendar by way of an application program interface (API).

Example 3 is a method as in any of Examples 1-2, further comprising establishing a secure communication link with the external calendar by way of the API.

Example 4 is a method as in any of Examples 1-3, wherein extracting data from the calendar comprises extracting data from each of an internal calendar and an external calendar, wherein data for the internal calendar is stored on a database, and wherein data for the external calendar is accessible in real-time by way of an API.

Example 5 is a method as in any of Examples 1-4, further comprising automatically scheduling at least one of the one or more personnel of the personnel-type to execute the project task within a task window.

Example 6 is a system. The system includes a database comprising a plurality of database instances, wherein each of the plurality of database instances is assigned to a client account. The system includes an execution platform comprising a plurality of processors configured to execute workflows based on data stored in the database.

Example 7 is a system as in Example 6, further comprising a data ingestion engine configured to aggregate data from a plurality of different data sources, wherein the data includes equipment data and personnel data.

Example 8 is a method as in any of Examples 1-7, wherein the personnel data includes a leading personnel datapoint and a subordinate personnel datapoint, and wherein the leading personnel datapoint is matched with the subordinate personnel datapoint based on metadata.

Example 9 is a method as in any of Examples 1-8, wherein the equipment data includes a parent asset and a child asset, and wherein the parent asset is matched with the child asset based on metadata.

Example 10 is a method as in any of Examples 1-9, wherein the equipment data includes a bundled asset, and wherein the bundled asset comprises a descriptor and a quantity.

Example 11 is a method as in any of Examples 1-10, wherein the quantity of the bundled asset is adjustable in real-time without adjusting the descriptor.

Example 12 is a method as in any of Examples 1-11, wherein the bundled asset is assigned to one or more of the subordinate personnel or the leading personnel by attaching assignment metadata to each of the bundled asset and the one or more of the leading personnel or the subordinate personnel.

Example 13 is a method as in any of Examples 1-12, wherein the database is organized into a plurality of data buckets, and wherein each of the plurality of data buckets is assigned to a project.

Example 14 is a method as in any of Examples 1-13, wherein a plurality of datapoints are associated with each data bucket, and wherein the plurality of datapoints comprises one or more of personnel data, equipment data, budget data, or contract data.

Example 15 is a method as in any of Examples 1-14, wherein read and write permissions are assigned to a user to access all data within the data bucket.

Example 16 is a method as in any of Examples 1-15, wherein read-only permissions are assigned to a user to access all data within the data bucket.

Example 17 is a method as in any of Examples 1-16, wherein read and write permissions are assigned to user to access only a portion of the data within the data bucket based on the type of data.

Example 18 is a method. The method includes receiving a candidate event to be stored on a cloud database, wherein the candidate event is provided by a remote data source, and wherein the remote data source generated the candidate event during an offline period when communication between the cloud database and the remote data source was unavailable. The method includes reconciling the candidate event against the cloud database by determining whether a conflicting event was stored on the cloud database during the offline period. The method includes, in response to determining there is no conflicting event stored on the cloud database during the offline period, committing the candidate event to the cloud database. The method is such that the remote data source comprises a local database instance comprising a copy of information stored on the cloud database.

Example 19 is a method as in Example 18, further comprising, in response to identifying the conflicting event stored on the cloud database during the offline period, determining whether the candidate event or the conflicting event should be stored on the cloud database.

Example 20 is a method as in any of Examples 18-19, wherein determining whether the candidate event or the conflicting event should be stored on the cloud database comprises: providing the candidate event to a user account; and receiving from the user account an approval or denial to commit the candidate event to the cloud database.

Example 21 is a method as in any of Examples 18-20, wherein determining whether the candidate event or the conflicting event should be stored on the cloud database comprises: identifying a candidate user account associated with submitting the candidate event; identifying a conflicting user account associated with submitting the conflicting event; and determining whether the candidate user account or the conflicting user account comprises greater permissions to write data to the cloud database.

Example 22 is a method as in any of Examples 18-21, further comprising, in response to determining the candidate user account comprises the greater permissions to write data to the cloud database, committing the candidate event to the cloud database; and wherein the cloud database is an append-only database.

Example 23 is a method as in any of Examples 18-22, further comprising, in response to determining the conflicting user account comprises the greater permissions to write data to the cloud database, declining to commit the candidate event to the cloud database.

Example 24 is a method as in any of Examples 18-23, wherein the candidate event comprises a first timekeeping update for a first personnel; wherein the conflicting event comprises a second timekeeping update for the first personnel; and wherein determining whether the candidate event or the conflicting event should be stored on the cloud database comprises determining whether the first timekeeping update or the second timekeeping update has an earlier timestamp.

Example 25 is a method as in any of Examples 18-24, further comprising: the remote data source storing a local copy of the candidate event on the local database instance in response to determining the communication between the cloud database and the remote data source is unavailable; and the remote data source automatically providing the candidate event to a server in response to the communication between the cloud database and the remote data source being restored.

Example 26 is a method as in any of Examples 18-25, further comprising: aggregating data from a plurality of different data sources, wherein the data comprises equipment data and personnel data pertaining to a project; generating a data bucket comprising information associated with the project for tracking the equipment data and the personnel data over time; storing the data bucket on the cloud database; and assigning permissions to different types of data stored in the data bucket such that a plurality of users of the cloud database have personalized read and write permissions to the equipment data and the personnel data.

Example 27 is a method as in any of Examples 18-26, further comprising, prior to committing the candidate event to the cloud database, cross-checking permissions on the cloud database to determine whether a user account associated with the remote data source has permission to amend data on the cloud database.

Example 28 is a system as in any of Examples 1-27, wherein the system comprises one or more processors configured to execute instructions stored in non-transitory computer readable storage medium, and wherein the instructions comprise any of the method steps described in any combination of any of Examples 1-27.

Example 29 is non-transitory computer readable storage medium storing instructions to be executed by one or more processors, and wherein the instructions comprise any of the method steps described in any combination of any of Examples 1-27.

The embodiments of systems, methods, and devices discussed herein may be applied to a wide range of sample types for detection of various particles, materials, or the like. The following paragraphs describe diverse types of samples which may be imaged and identified using methods, systems, or devices disclosed herein.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components, which is a term used to emphasize their implementation independence more particularly. For example, a component may be implemented as a hardware circuit comprising custom very large-scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by diverse types of processors. An identified component of executable code may, for instance, include one or more physical or logical blocks of computer instructions, which may, for instance, be organized as an object, a procedure, or a function. Nevertheless, the executables of an identified component need not be physically located together but may include disparate instructions stored in separate locations that, when joined logically together, include the component, and achieve the stated purpose for the component.

Indeed, a component of executable code may be a single instruction, or many instructions, and may even be distributed over several different code segments, among different programs, and across several memory devices. Similarly, operational data may be identified and illustrated herein within components and may be embodied in any suitable form and organized within any suitable type of data structure. The operational data may be collected as a single data set or may be distributed over separate locations including over different storage devices, and may exist, at least partially, merely as electronic signals on a system or network. The components may be passive or active, including agents operable to perform desired functions.

Implementations of the disclosure can also be used in cloud computing environments. In this application, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS)), and deployment models (e.g., private cloud, community cloud, public cloud, hybrid cloud, or any suitable service type model now known to those of ordinary skill in the field, or later discovered). Databases and servers described with respect to the disclosure can be included in a cloud model.

Reference throughout this specification to “an example” means that a particular feature, structure, or characteristic described in connection with the example is included in at least one embodiment of the disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the disclosure may be referred to herein along with alternatives for the various components thereof. It is understood that such embodiments, examples, and alternatives are not to be construed as de facto equivalents of one another but are to be considered as separate and autonomous representations of the disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the disclosure should, therefore, be determined only by the claims, if any.

What is claimed is:

1. A method comprising:
receiving a candidate event to be stored on a cloud database, wherein the candidate event is provided by a remote data source, and wherein the remote data source generated the candidate event during an offline period when communication between the cloud database and the remote data source was unavailable;
reconciling the candidate event against the cloud database by determining whether a conflicting event was stored on the cloud database during the offline period; and
in response to determining there is no conflicting event stored on the cloud database during the offline period, committing the candidate event to the cloud database;
wherein the remote data source comprises a local database instance comprising a copy of information stored on the cloud database.

2. The method of claim 1, further comprising, in response to identifying the conflicting event stored on the cloud database during the offline period, determining whether the candidate event or the conflicting event should be stored on the cloud database.

3. The method of claim 2, wherein determining whether the candidate event or the conflicting event should be stored on the cloud database comprises:
providing the candidate event to a user account; and
receiving from the user account an approval or denial to commit the candidate event to the cloud database.

4. The method of claim 2, wherein determining whether the candidate event or the conflicting event should be stored on the cloud database comprises:
identifying a candidate user account associated with submitting the candidate event;
identifying a conflicting user account associated with submitting the conflicting event; and
determining whether the candidate user account or the conflicting user account comprises greater permissions to write data to the cloud database.

5. The method of claim 4, further comprising, in response to determining the candidate user account comprises the greater permissions to write data to the cloud database, committing the candidate event to the cloud database; and
wherein the cloud database is an append-only database.

6. The method of claim 4, further comprising, in response to determining the conflicting user account comprises the greater permissions to write data to the cloud database, declining to commit the candidate event to the cloud database.

7. The method of claim 2, wherein the candidate event comprises a first timekeeping update for a first personnel;
wherein the conflicting event comprises a second timekeeping update for the first personnel; and
wherein determining whether the candidate event or the conflicting event should be stored on the cloud database comprises determining whether the first timekeeping update or the second timekeeping update has an earlier timestamp.

8. The method of claim 1, further comprising:
the remote data source storing a local copy of the candidate event on the local database instance in response to determining the communication between the cloud database and the remote data source is unavailable; and
the remote data source automatically providing the candidate event to a server in response to the communication between the cloud database and the remote data source being restored.

9. The method of claim 1, further comprising:
aggregating data from a plurality of different data sources, wherein the data comprises equipment data and personnel data pertaining to a project;
generating a data bucket comprising information associated with the project for tracking the equipment data and the personnel data over time;
storing the data bucket on the cloud database; and
assigning permissions to different types of data stored in the data bucket such that a plurality of users of the cloud database have personalized read and write permissions to the equipment data and the personnel data.

10. The method of claim 1, further comprising, prior to committing the candidate event to the cloud database, cross-checking permissions on the cloud database to determine whether a user account associated with the remote data source has permission to amend data on the cloud database.

11. A system comprising:
a cloud database in communication with a network; and
a server in communication with the cloud database over the network, wherein the server comprises one or more processors configured to execute instructions stored in non-transitory computer readable storage medium, and wherein the instructions comprise:
receiving a candidate event to be stored on the cloud database, wherein the candidate event is provided by a remote data source, and wherein the remote data source generated the candidate event during an offline period when communication between the cloud database and the remote data source was unavailable;
reconciling the candidate event against the cloud database by determining whether a conflicting event was stored on the cloud database during the offline period; and
in response to determining there is no conflicting event stored on the cloud database during the offline period, committing the candidate event to the cloud database;
wherein the remote data source comprises a local database instance comprising a copy of information stored on the cloud database.

12. The method of claim 11, wherein the instructions further comprise, in response to identifying the conflicting event stored on the cloud database during the offline period, determining whether the candidate event or the conflicting event should be stored on the cloud database.

13. The method of claim 12, wherein the instructions are such that determining whether the candidate event or the conflicting event should be stored on the cloud database comprises:
providing the candidate event to a user account; and
receiving from the user account an approval or denial to commit the candidate event to the cloud database.

14. The method of claim 12, wherein the instructions are such that determining whether the candidate event or the conflicting event should be stored on the cloud database comprises:
identifying a candidate user account associated with submitting the candidate event;
identifying a conflicting user account associated with submitting the conflicting event; and
determining whether the candidate user account or the conflicting user account comprises greater permissions to write data to the cloud database.

15. The method of claim 14, wherein the instructions further comprise, in response to determining the candidate user account comprises the greater permissions to write data to the cloud database, committing the candidate event to the cloud database; and
wherein the cloud database is an append-only database.

16. The method of claim 14, wherein the candidate event comprises a first timekeeping update for a first personnel;
wherein the conflicting event comprises a second timekeeping update for the first personnel; and
wherein the instructions are such that determining whether the candidate event or the conflicting event should be stored on the cloud database comprises determining whether the first timekeeping update or the second timekeeping update has an earlier timestamp.

17. The method of claim 11, wherein the instructions further comprise:
the remote data source storing a local copy of the candidate event on the local database instance in response to determining the communication between the cloud database and the remote data source is unavailable; and
the remote data source automatically providing the candidate event to a server in response to the communication between the cloud database and the remote data source being restored.

18. The method of claim 11, wherein the instructions further comprise:
aggregating data from a plurality of different data sources, wherein the data comprises equipment data and personnel data pertaining to a project;
generating a data bucket comprising information associated with the project for tracking the equipment data and the personnel data over time;
storing the data bucket on the cloud database; and
assigning permissions to different types of data stored in the data bucket such that a plurality of users of the cloud database have personalized read and write permissions to the equipment data and the personnel data.

19. The method of claim 11, wherein the instructions further comprise, further comprising, prior to committing the candidate event to the cloud database, cross-checking permissions on the cloud database to determine whether a user account associated with the remote data source has permission to amend data on the cloud database.

20. Non-transitory computer readable storage medium storing instructions to be executed by one or more processors, wherein the instructions comprise:
receiving a candidate event to be stored on a cloud database, wherein the candidate event is provided by a remote data source, and wherein the remote data source generated the candidate event during an offline period when communication between the cloud database and the remote data source was unavailable;
reconciling the candidate event against the cloud database by determining whether a conflicting event was stored on the cloud database during the offline period; and
in response to determining there is no conflicting event stored on the cloud database during the offline period, committing the candidate event to the cloud database;
wherein the remote data source comprises a local database instance comprising a copy of information stored on the cloud database.
